(19) United States
(12) Patent Application Publication
(10) Pub. No.: US 2010/0251790 A1
(43) Pub. Date: Oct. 7, 2010

(54) GRANULAR ORGANIC FERTILIZER

(76) Inventors: Willem Abraham Van Rooijen, Vereeniging (ZA); Louis Johannes Klue, Sasolburg (ZA)

Correspondence Address: NIXON PEABODY, LLP, 401 9TH STREET, NW, SUITE 900, WASHINGTON, DC, 20004-2128, US

(21) Appl. No.: 12/677,941

(22) PCT Filed: Sep. 12, 2008
(86) PCT No.: PCT/IB2008/053684

§ 371 Date: Jun. 16, 2010

(30) Foreign Application Priority Data
Sep. 14, 2007 (ZA) 2007/07908

(51) Int. Cl. C05F 11/02

(52) U.S. Cl. 71/24

(57) ABSTRACT

This invention relates to a process for producing a granular dry organic fertilizer and the fertilizer produced by the process. The process includes the steps of providing a peat with a pH of 6-7; if necessary, sifting the peat through a sieve to remove fibres bigger than 4 mm; treating the peat with a base and forming a mixture; treating the mixture with an organic acid such as propionic acid, EDTA, amino acids, fulvic acid; and then granulating the mixture to produce a granulated dry organic carbon fertilizer which is pH buffered at 6-7. This granular fertilizer is a complete fertilizer and is acceptable for the use in organic farming all over the world.

### BACKGROUND OF THE INVENTION

This invention relates to a granular organic fertilizer.

International Patent Publication No. WO 2007/072161 discloses a process for manufacturing a dry organic fertilizer using peat.

It is an object of this invention to provide an improved dry organic fertilizer product.

### SUMMARY OF THE INVENTION

According to the invention there is provided a process for producing a granular dry organic fertilizer, the process including the steps of:
1) providing a peat, preferably bituminous peat with a pH of 6- 7, typically 6.8;
2) if necessary, sifting the peat through a sieve to remove fibres bigger than 4 mm, preferably to remove fibres bigger than 2 mm;
3) treating the peat with a base such as NaOH or KOH, typically NaOH and forming a mixture;
4) treating the mixture with an organic acid such as propionic acid, EDTA, amino acids, fulvic acid, preferably propionic acid;
5) blending the mixture; and then
6) granulating the mixture to produce a granulated dry organic carbon fertilizer which is pH buffered at 6-7, typically 6.5-6.8.

In step 3), 5-20%, typically 5-10% of the final volume of the mixture of base is added to the peat and mixed for 2-10, typically ±5 minutes.

In step 4), 2-10 Liters (1-10 kg), typically 5 Liters (kg) organic acid is added per 1000 kg mixture and mixed for 3-5 minutes.

Chemical nutrients such as potassium, phosphates, calcium, magnesium, nitrogen (ammonium sulphate) and chelated micro nutrients may be added to the mixture during the blending step 5), according to a required blend, for example: 8:3:5+Ca+Mg+micro elements.

The granulating step 6) may take place in a pan granulator using a 1-4 mm, typically a 2 mm stainless steel mesh and a binder.

The binder may constitute 0.3%-1%, typically 0.3%-0.5% by weight of the mixture and is preferably a starch, most preferably a maize starch.

Granules produced in the process typically have a size from 2-6 mm, preferably 2-4 mm.

In step 6), the mixture to be granulated typically contains 15-20%, typically 18% by weight moisture.

The invention also relates to a granular dry organic fertilizer containing peat, preferably bituminous peat, which is pH buffered at 6-7, typically 6.5-6.8.

Preferably, the granular dry organic fertilizer contains nutrients which are chelated or clustered by the carbon in the peat.

The chemical nutrients may be one or more of potassium, phosphates, calcium, magnesium, nitrogen (ammonium sulphate) and chelated micro nutrients.

### DETAILED DESCRIPTION

In accordance with a process of the invention, bituminous peat (peat which originates from macro plants (reeds and trees) growing in swamps) having a pH of 6-7, typically 6.8, is sifted through mesh 2-4 mm in order to remove fibers. Fine peat with a moisture content of between 20and 25% is then used as a carrier for the manufacturing of a granular dry organic fertilizer. The average carbon content of the sifted peat is between 45 and 55 percent.

### Step 1

The sifted peat, between 40 and 60 percent of the final mix, is placed into a blender. Ammonium hydroxide, 5-10 percent of the final volume, is added to the peat and mixed for ±5 minutes. 5 Liters or 5 kg per 1000 kg propionic acid (25%) or EDTA is then added and mixed for 3-5 minutes. Nutrients (chemical) such as potassium, phosphates, calcium, magnesium, nitrogen (ammonium sulphate) and chelated micro nutrients are then added to the peat into the blender, according to the required blend, for example: 8:3:5+Ca+Mg+micro elements. The ratio of solubility of each element as the total volume of the added chemical nutrients must be dissolved and absorbed or adsorbed into or onto the peat carrier. Once the chemicals are added, the blending continues until the blend is homogeneous.

### Step 2

The mixture (containing 18% moisture) is then granulated in a pan granulator using 2 mm stainless steel mesh, 0.3%-0.5% maize starch as a binder to provide granules which are 2-4 mm in size.

### Step 3

The granules are dried in an air draft at a temperature of 200° C. to 400° C. Thereafter the granules are allowed to cool down to 40° C. after granulation and are left for +/−8 hours to harden before bagging.

The granulated dry organic fertilizer is a complete slow release fertilizer (all nutrients). Less fertilizer is needed as loss of nutrients through leaching or fixing takes place as all nutrients are released from the peat carrier and is not subject to cation exchange capacity from the clay/soil particles. All nutrients are chelated or clustered by the carbon in the peat carrier. By using the granulated organic product that is pH buffered at 6.5-6.8, the pH of the soil plays a minor role in the availability of the nutrients to the plants as the nutrients required by the specific crop are readily available (open hydroponics).

As the nutrients are released from the carrier, the carbon that remains in the soil serves as a nutrient for microorganisms and earthworms in the soil, thus increasing the organic carbon content of the soil with all the benefits of organic soils.

As the peat is completely anaerobic composted no nitrogen negative periods are experienced as is the case with animal droppings or compost.

A further benefit of the increased carbon content of the soil is that parasitic organisms such as nematodes feed on the carbon in the soil and consequently far less damage to the plant roots. The binding of nitrogen by free-living bacteria in the soil is much enhanced, as the population of the nitrogen binding organisms increase with availability of carbon in the soil, thus far less applied nitrogen is needed reducing the pollution of run off water and ground water.

Further benefits of these organic nutrients are that all nutrients required by the plants can be bound together in the organic carrier, thus making it more user friendly, especially for the subsistence farmers in Africa.

This granular fertilizer is a complete fertilizer and is acceptable for the use in organic farming all over the world.

1. A process for producing a granular dry organic fertilizer, the process including the steps of:
1) providing a peat;
2) if necessary, sifting the peat through a sieve to remove fibres bigger than 4 mm;
3) treating the peat with a base and forming a mixture;
4) treating the mixture with sufficient amount of an organic acid to buffer the mixture at a pH of 6-7, typically 6.5-6.8;
5) blending the mixture; and
6) granulating the mixture to produce a granulated dry organic carbon fertilizer which is pH buffered at 6-7, typically 6.5-6.8.

2. The process according to claim 1, wherein the peat is bituminous peat.

3. The process according to claim 1, wherein the peat has a pH of 6-7.

4. The process according to claim 3, wherein the peat has a pH of 6.8.

5. The process according to claim 1, wherein, in step 2), the peat is sifted to remove fibres bigger than 2 mm.

6. The process according to claim 1, wherein, in step 3), the base is NaOH or KOH.

7. The process according to claim 6, wherein, in step 3), the base is NaOH.

8. The process according to claim 1, wherein, in step 4), the organic acid is propionic acid, EDTA, amino acids, fulvic acid.

9. The process according to claim 8, wherein, in step 4), the organic acid is propionic acid.

10. The process according to claim 1, wherein, in step 3), the peat is treated with sufficient amount of an organic acid to buffer the mixture at a pH of 6-7.

11. The process according to claim 10, wherein, in step 3), the peat is treated with sufficient amount of an organic acid to buffer the mixture at a pH of 6.5-6.8.

12. The process according to claim 1, wherein, in step 3), 5-20% of the final volume of the mixture of base is added to the peat.

13. The process according to claim 12, wherein, in step 3), 5-10% of the final volume of the mixture of base is added to the peat.

14. The process according to claim 1, wherein, in step 3), the peat is treated for 2-10 minutes.

15. The process according to claim 14, wherein, in step 3), the peat is treated for ±5 minutes.

16. The process according to claim 1, wherein, in step 4), 2-10 Liters (2-10 kg) organic acid per 1000 kg mixture is added.

17. The process according to claim 1, wherein, in step 4), the peat is treated for 3-5 minutes.

18. The process as claimed in claim 1, wherein chemical nutrients such as potassium, phosphates, calcium, magnesium, nitrogen (ammonium sulphate) and chelated micro nutrients are added to the mixture during the blending step 5), according to a required blend.

19. The process as claimed in claim 18, wherein the chemical nutrients are selected from potassium, phosphates, calcium, magnesium, nitrogen (ammonium sulphate) and chelated micro nutrients.

20. The process as claimed in claim 19, wherein the chemical nutrients are added in the following ratio: 8:3:5+Ca+Mg+micro elements.

21. The process as claimed in claim 1, wherein the granulating step 6) takes place in a pan granulator using a binder.

22. The process according to claim 21, wherein the binder constitutes 0.3%-1% by weight of the mixture.

23. The process according to claim 22, wherein the binder constitutes 0.3%-0.5% by weight of the mixture.

24. The process according to claim 21, wherein the binder is a starch.

25. The process according to claim 1, wherein the granules produced in the process have a size from 2-6 mm.

26. The process according to claim 25, wherein the granules produced in the process have a size from 2-4 mm.

27. The process according to claim 1, wherein, in step 6), the mixture to be granulated contains 15-20% by weight moisture.

28. The process according to claim 27, wherein, in step 6), the mixture to be granulated contains 18% by weight moisture.

29. A granular dry organic fertilizer containing peat, which is pH buffered at 6-7.

30. The granular dry organic fertilizer according to claim 29, wherein the peat is bituminous peat.

31. The granular dry organic fertilizer according to claim 29 or 30, which is pH buffered at 6.5-6.8.

32. The granular dry organic fertilizer according to claim 29 containing nutrients which are chelated or clustered by the carbon in the peat.

33. The granular dry organic fertilizer according to claim 32, wherein the chemical nutrients are selected from one or more of potassium, phosphates, calcium, magnesium, nitrogen (ammonium sulphate) and chelated micro nutrients.
